(19) United States
(12) Patent Application Publication
(10) Pub. No.: US 2014/0218303 A1
(43) Pub. Date: Aug. 7, 2014

(54) HAPTIC FEEDBACK KEYBOARD STRUCTURE

(71) Applicants: DARFON ELECTRONICS CORP., Taoyuan (TW); DARFON ELECTRONICS (SUZHOU) CO., LTD., Suzhou (CN)

(72) Inventors: Huang-Hsiao Kao, Taoyuan (TW); Fei-Ya Chen, Taoyuan (TW)

(73) Assignees: DARFON ELECTRONICS CORP., Taoyuan (TW); DARFON ELECTRONICS (SUZHOU) CO., LTD., Suzhou (CN)

(21) Appl. No.: 14/173,820

(22) Filed: Feb. 6, 2014

(30) Foreign Application Priority Data
Feb. 6, 2013 (TW) 102104653

(51) Int. Cl. G06F 3/01

(52) U.S. Cl. CPC G06F 3/016
USPC 345/168

(57) ABSTRACT

A haptic feedback keyboard structure includes a base plate, a keyboard frame, a haptic feedback device, a touch sensor and a plurality of touch units. The keyboard frame is disposed on the base plate. The haptic feedback device is disposed between the base plate and the keyboard frame, and the haptic feedback device includes a vibrating plate. The touch sensor is disposed under the keyboard frame for triggering the vibrating plate to vibrate. The plurality of touch units is respectively connected to the keyboard frame and adjacent to a side of the touch sensor. The touch sensor triggers the vibrating plate to transmit a vibrating force to one of the plurality of touch units as the one of the plurality of touch units is pressed.

### BACKGROUND OF THE INVENTION

1. Field of the Invention

The present invention relates to a haptic feedback keyboard structure, and more particularly, to a haptic feedback keyboard structure capable of generating haptic feedback.

2. Description of the Prior Art

An input device is in widespread use as the development and research of various electronic devices. There are common input devices such as a keyboard, a touch pad and a mouse. For example, the keyboard includes a plurality of keyswitches. Each keyswitch corresponds to a specific character or symbol so as to input a signal corresponding to the character or symbol to the electronic devices as the keyswitch is pressed. A conventional keyswitch includes a keycap, a scissor structure, a resilient supporting component (e.g., a rubber sheet) and a base plate. The scissor structure and the resilient supporting component are disposed between the base plate and the keycap for supporting the keycap and driving the keycap to move relative to the base plate, so that the keycap moves up and down due to the operation of a user.

However, a conventional scissor structure is made of plastic material. Two brackets of the scissor structure are molded and then assembled manually, so as to make the two brackets capable of pivoting relative to each other. The manufacture of the conventional scissor structure has drawbacks of high cost of the mold, time consuming assembly of the brackets, being easily broken of the brackets caused by a small shaft utilized in pivotally connection, and insufficient strength of plastic material, which means a thickness of the plastic must be increased to improve the strength, and the increased thickness affects an overall height of the key structure so as not to contribute to thinning design.

In addition, a thinning keyboard with the thinner overall thickness causes a limitation of pressing movement of the keyswitches, so that the user may not obviously feel the keyswitches being pressed. It is an important issue to increase haptic feedback in response of the pressing keyswitches when using the keyboard.

### SUMMARY OF THE INVENTION

The present invention is to provide a haptic feedback keyboard structure capable of generating haptic feedback as a keycap of the haptic feedback keyboard structure is pressed so as to increase haptic sensation in response of operation, to solve the above drawbacks.

According to the disclosure, a haptic feedback keyboard structure includes a base plate, a keyboard frame, a haptic feedback device, a touch sensor and a plurality of touch units. The keyboard frame is disposed on the base plate. The haptic feedback device is disposed between the base plate and the keyboard frame, and the haptic feedback device includes a vibrating plate. The touch sensor is disposed under the keyboard frame for triggering the vibrating plate to vibrate. The plurality of touch units is respectively connected to the keyboard frame and adjacent to the touch sensor. When either one of the plurality of touch units is pressed, the touch sensor triggers the vibrating plate to transmit a vibrating force to the pressed touch unit.

According to the disclosure, a haptic feedback keyboard structure includes a base plate, a keyboard frame, a plurality of touch units, a haptic feedback device, and a plurality of switching units. The keyboard frame is disposed on the base plate. Each of the plurality of touch units includes a keycap and a resilient connecting component disposed between the keycap and the keyboard frame, so that the keycap capable to move up and down relative to the keyboard frame. The haptic feedback device is disposed between the base plate and the keyboard frame, and the haptic feedback device extended across and under the plurality of touch units. Each of the plurality of switching units is disposed between one of the plurality of keycaps and the haptic feedback device. When one of the plurality of touch units is pressed to move the corresponding keycap downward to contact against the corresponding switching unit, so that the corresponding switching unit contacts against the haptic feedback device. The haptic feedback device is triggered and transmits a vibrating force to the pressed keycap through the contacted switching unit, and the resilient connecting component reduce the vibrating force further transmitting from the pressed keycap to the keyboard frame. Meanwhile the other of the plurality of touch units is not pressed so that the corresponding switching units do not move downward to contact against the haptic feedback device, and the unpressed touch units do not receive the vibrating force to substantially remain motionless.

The haptic feedback keyboard structure of the present invention generates haptic feedback so as to provide the haptic sensation in response of the operation when the keycap is pressed. In addition, the haptic feedback keyboard structure of the present invention includes thinner touch units so as to reduce a total thickness of the haptic feedback keyboard structure. Comparing with the conventional scissor structure, the thinner touch units with smaller pressing movement of the present invention can keep tactile sensation by the vibrating force generated by the haptic feedback device. Besides, the keycap, the resilient connecting component and the keyboard frame can be formed integrally to reduce components and simplify the assembly process so as to decrease the cost in molding. Therefore, the integral haptic feedback keyboard structure of the present invention has less weight and reduced thickness.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a haptic feedback keyboard structure according to an embodiment of the present invention.

FIG. 2 is a cross-sectional diagram of a keycap of the haptic feedback keyboard structure being pressed according to the embodiment of the present invention.

FIG. 3 is a diagram illustrated an arrangement of keycaps of a standard keyboard according to the embodiment of the present invention.

FIG. 4 is a diagram illustrated different keycaps with different touch units being contained in partition portions of the same opening according to another embodiment of the present invention.

FIG. 5 to FIG. 10 are cross-sectional diagrams of feedback keyboard structures according to different embodiments of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive.

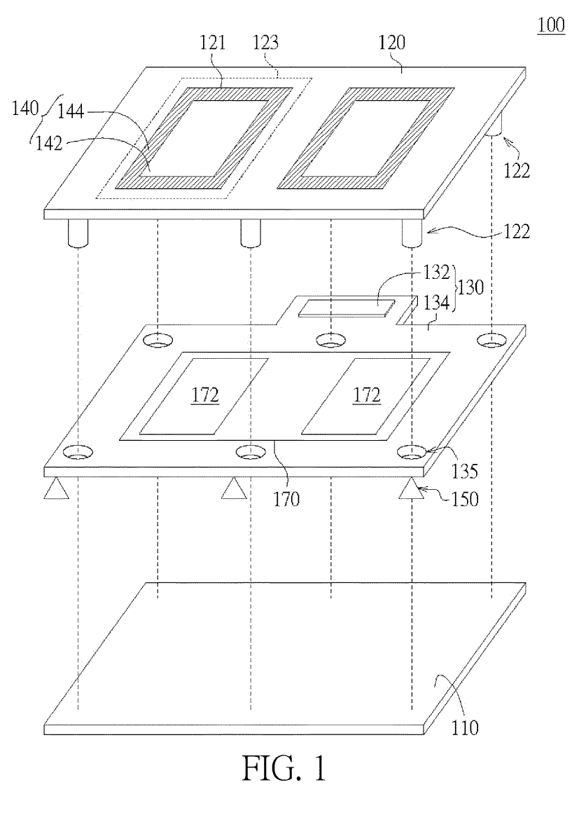

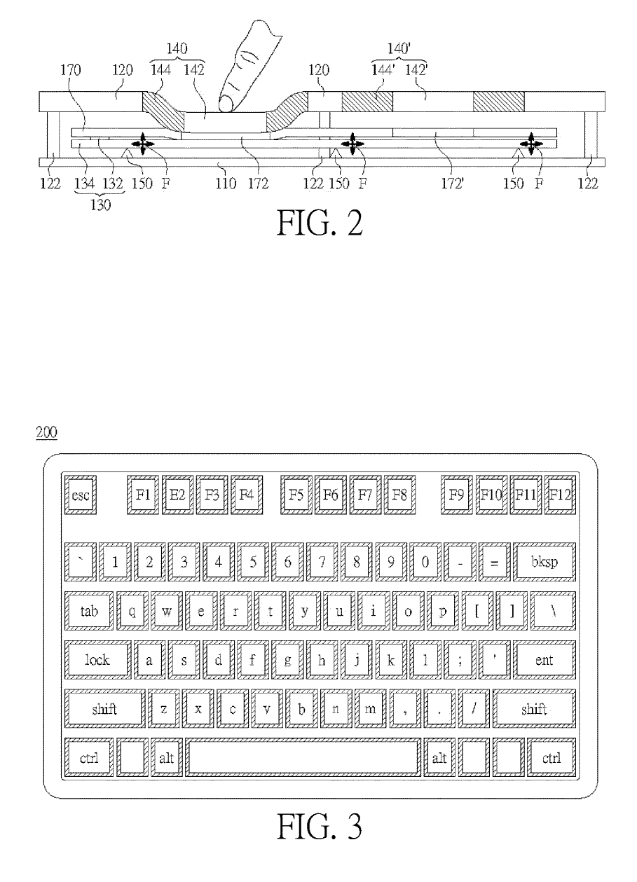

Please refer to FIG. 1 and FIG. 2. FIG. 1 is an exploded diagram of a haptic feedback keyboard structure 100 according to an embodiment of the present invention. FIG. 2 is a cross-sectional diagram of a keycap 142 of the haptic feedback keyboard structure 100 being pressed according to the embodiment of the present invention. The haptic feedback keyboard structure 100 includes a base plate 110, a keyboard frame 120, a haptic feedback device 130, a plurality of touch units 140 and a touch sensor 170. The keyboard frame 120 is disposed on the base plate 110. The haptic feedback device 130 is disposed between the base plate 110 and the keyboard frame 120, and the haptic feedback device 130 is extended across and under the plurality of touch units 140. The haptic feedback device 130 includes a vibrating plate 134 and an actuator 132. The touch sensor 170 is disposed between the keyboard frame 120 and the vibrating plate 134 for triggering the vibrating plate 134 to vibrate. The plurality of touch units 140 is respectively connected to the keyboard frame 120 and adjacent to a side of the vibrating plate 134. As shown in FIG. 2, when either one of the plurality of touch units 140 is pressed, the touch sensor 170 triggers the vibrating plate 134 to transmit a vibrating force F to the pressed touch unit 140. Thus, the feedback keyboard structure 100 generates haptic feedback in response of operation, such as pressing the touch unit 140 by a finger as shown in FIG. 2.

As shown in FIG. 1, the keyboard frame 120 includes a plurality of partition portions 123 and a plurality of opening 121. Each opening 121 contains one plurality of touch units 140. Each touch unit 140 includes a keycap 142 and a resilient connecting component 144, and the resilient connecting component 144 formed between the corresponding keycap 142 and the keyboard frame 120. The resilient connecting component 144 is an annular rubber with compressibility and stretchability. The resilient connecting component 144 surrounds the keycap 142 to (1) support the keycap 142 in a higher position, and (2) absorb vibration so as to reduce the vibrating force F transmitted from the keycaps 142 to the keyboard frame 120.

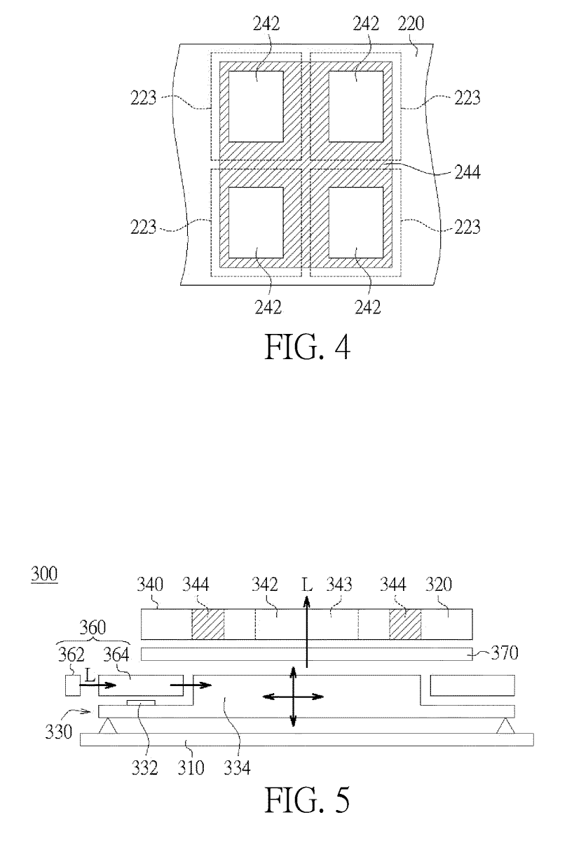

There are two touch units 140 shown in FIG. 1, but a number of the touch units 140 can be increased or decreased according to a number of the keycaps 142. Please refer to FIG. 3. FIG. 3 is a diagram illustrated an arrangement of the keycaps 142 of a standard keyboard 200 according to the embodiment of the present invention. The standard keyboard 200 shown in FIG. 3 is just a type of the arrangement of the keycaps 142, but the present invention is not limited to this.

According to the embodiment, the haptic feedback keyboard structure 100 includes a plurality of bosses 122 for supporting the keyboard frame 120 on the base plate 110. Thus, the keyboard frame 120 can be disposed on the base plate 110 stably, and a gap is formed between the keyboard frame 120 and the base plate 110 by the bosses 122. In addition, the vibrating plate 134 is disposed between the keyboard frame 120 and the base plate 110, so that each of the plurality of the touch units 140 is adjacent to a side of the vibrating plate 134 without contacting to the vibrating plate 134 as not being pressed. As shown in FIG. 1, a plurality of holes 135 is formed on the vibrating plate 134 corresponding to the bosses 122, so that the bosses 122 pass through the holes 135 of the vibrating plate 134 and do not affect vibration of the vibrating plate 134.

The coordination of the bosses 122 and the holes 135 is according to an embodiment, and the present invention is not limited to this. For example, positions of the bosses 122 can be changed. The bosses 122 can be disposed around the keyboard frame 120, instead of being disposed on a central section of the keyboard frame 120, and the bosses 122 do not have to pass through the vibrating plate 134 so that it is unnecessary to dispose the holes 135 for the bosses 122. Furthermore, a shape and a number of the vibrating plate 134 can be adjusted. The vibrating plate 134 can be shaped of annularity or grid, or can be separated into pieces of vibrating plates, so as to dodge the bosses 122, so that it is unnecessary to dispose the holes 135 for the bosses 122.

According to this embodiment, the touch sensor 170 can be a thin film switch or a capacitive touch panel. As shown in FIG. 1, the touch sensor 170 includes a plurality of switching units 172 respectively corresponding to the plurality of touch units 140.

As shown in FIG. 2, as the touch unit 140 on a left side is pressed, the keycap 142 on the left side moves downward to contact against the corresponding switching unit 172 on the left side, so that the switching unit 172 on the left side contacts against the haptic feedback device 130 for triggering the haptic feedback device 130 to vibrate and is actuated so as to send a signal representing a character or symbol of the keycap 142 simultaneously. The haptic feedback device 130 transmits the vibrating force F to the pressed keycap 142 on the left side through the contacted switching unit 172, so that a user feels vibrating haptic feedback through a finger pressing on the keycap 142 on the left side.

In addition, the resilient connecting component 144 on the left side reduces the vibrating force F transmitted from the pressed keycap 142 on the left side to the keyboard frame 120. A touch unit 140′ on a right side is not pressed, and a corresponding keycap 142′ on the right side and a switching unit 172′ on the right side do not move downward so as not to contact against the haptic feedback device 130. The unpressed touch unit 140′ on the right side does not receive the vibrating force F to remain motionless.

In addition, each keycap 142 responses the press by the user to move up and down through the resilient component 144, and the keycap 142 vibrates during the process of being pressed downward and contacting with the vibrating plate 134, so as to increase the haptic feedback.

The keycap 142 and the resilient connecting component 144 can be formed integrally. The keycap 142 and the resilient connecting component 144 can be made of the same material or different materials. For example, the keycap 142 and the resilient connecting component 144 can be made of rubber, or the keycap 142 is made of plastic and the resilient connecting component 144 is made of rubber. As the keycap 142 and the resilient connecting component 144 are made of the same material, such as rubber, a rubber forming the keycap 142 can be harder than a rubber forming the resilient connecting component 144. The keycap 142 is made of hard rubber so as to enhance flatness and the pressure resistance of a contacting surface. Meanwhile, the resilient connecting component 144 is made of soft rubber so as to enhance deformation of the resilient connecting component 144 to prevent elastic fatigue or damage for increasing a service life of the resilient connecting component 144.

The keycap 142 and the resilient connecting component 144 can be preferably formed with the keyboard frame 120 integrally by an insert molding manner, so as to form a thin keyboard structure. The keyboard is formed integrally to reduce components of the feedback keyboard structure 100 and simplify the assembly process so as to decrease the cost in molding. In addition, the integral feedback keyboard structure 100 has less weight and reduced thickness.

The keyboard frame 120 includes a plurality of partition portions 123 for respectively containing the plurality of keycaps 124, and each of the partition portions 123 has a shape corresponding to a shape of the contained keycap 124. As shown in FIG. 1, two keycaps 142 of the touch units 140 are contained in different partition portions 123 of different openings 121. The vibration generated by pressing the single keycap 142 to contact the vibrating plate 134 can be completely absorbed by the resilient connecting component 144, so that the vibration does not affect the other adjacent keycap 142. However, the above-mentioned disposal of the keycap 142 is one of the embodiments of the present invention, and the present invention is not limited to this. Different keycaps 142 of the touch units 140 can be contained in the partition portions 123 of the same opening.

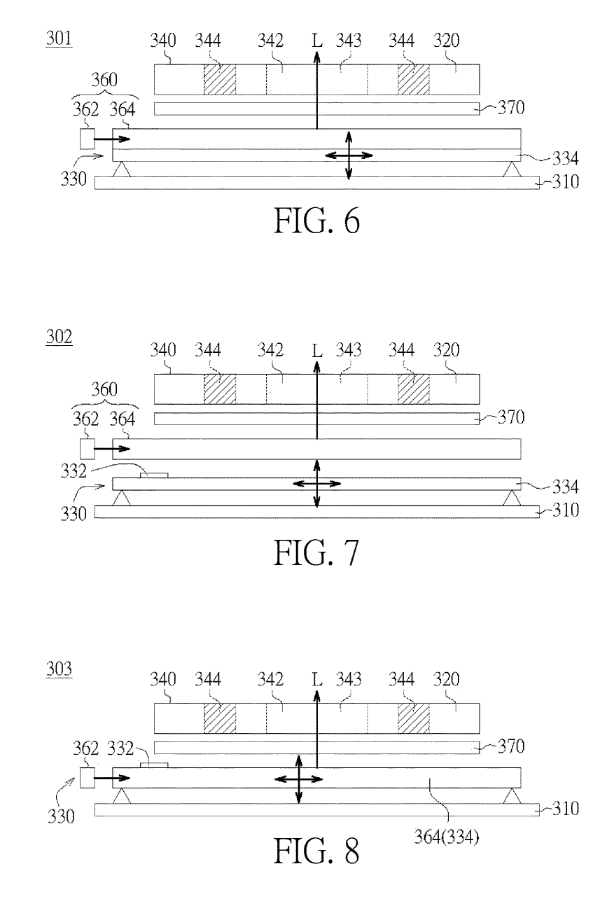

Please refer to FIG. 4. FIG. 4 is a diagram illustrated different keycaps 242 with different touch units 240 being contained in partition portions 232 of the same opening according to another embodiment of the present invention. In this embodiment, a resilient component 244 surrounds edges of the keycaps 242 and the partition portions 232 to form a four-grid frame structure. Gaps between the keyboard frame and each of the plurality of keycaps are substantially the same, and widths of edges of the resilient connecting component 244 surrounding the keycaps 242 are substantially equal. Four keycaps 242 of the corresponding touching units 240 are contained in four partition portions 223 with same shapes, and the four partition portions 223 are disposed in the same opening. The vibration generated from pressing one of the keycaps 242 to contact the vibrating plate 134 can be completely absorbed by the resilient connecting component 244, so that the vibration does not affect other adjacent keycaps 242.

In addition, the feedback keyboard structure 110 further includes a vibration damper 150 disposed between the vibrating plate 134 and the base plate 110 for preventing the base plate 110 from contacting the vibrating plate 134 so as to generate vibration. For example, please refer to FIG. 1 and FIG. 2. The vibration damper 150 is disposed around the vibrating plate 134, that is, a surrounding section of the keycap 142 outside a pressing section, but not limited to this. The vibration damper 150 can be disposed on a position where the keycap 142 is pressed and between the base plate 110 and the vibrating plate 134. The vibration damper 150 reduces the vibration transmitted from the vibrating plate 134 to the base plate 110. The vibration damper 150 can be a spring, a hydraulic damper, a pneumatic damper, or a porous damping material, such as foam, sponge, a damping pad or damping rubber.

The haptic feedback device 130 generates haptic feedback in response of the operation of the user through the vibrating plate 134 capable of transmitting the vibrating force F to the pressed touch unit 140. The haptic feedback device 130 includes the actuator 132 to generate the vibrating force F for haptic feedback. The actuator 132 is connected to the vibrating plate 134 so as to transmit the vibrating force F to the pressed touch unit 140 through the vibrating plate 134. Please refer to FIG. 1 and FIG. 2. The actuator 132 can be attached on a side position adjacent to an edge of the vibrating plate 134. The vibrating plate 134 starts to vibrate as the actuator 132 vibrates. That is, the actuator 132 can be turned on or turned off to control vibration of the vibrating plate 134. For example, the switching unit 172 is actuated so that the vibrating plate 134 starts to vibrate as sensing the keycap 142 is pressed by the user, and the vibrating plate 132 stops vibrating as sensing the switching unit 172 is not actuated.

The actuator 132 can be a vibrating motor, a piezoelectric actuator, an eletroactive polymer (EAP), or magnetorheological fluid (MR Fluid). The actuator 132 can provide the vibrating force F in a vertical direction, a horizontal direction or an all direction. Preferably, the actuator 132 provides the vibrating force F with directions including the vertical direction. Vibration frequency, vibration amplitude and vibration direction of the vibration of the actuator 132 are not limited, and it can be adjusted according to the pressing movement of the keycap 142 and/or the distance between the vibrating plate 134 and the keyboard frame 120.

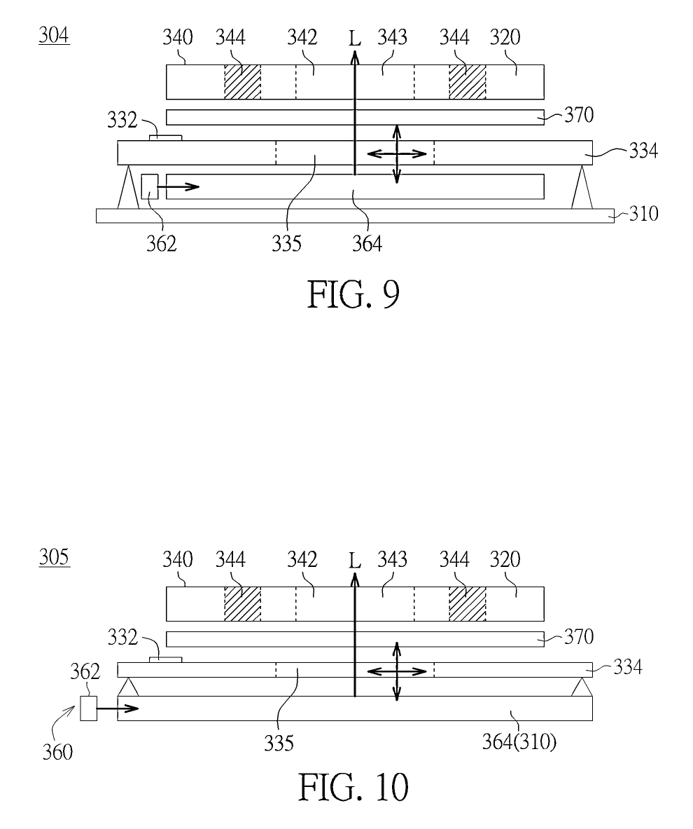

Please refer to FIG. 5 to FIG. 10. FIG. 5 to FIG. 10 are cross-sectional diagrams of feedback keyboard structures according to different embodiments of the present invention. FIG. 5 illustrates a cross-sectional diagram of a feedback keyboard structure 300. A keycap 342 and a resilient connecting component 344 are preferably formed integrally with a keyboard frame 320 in an insert molding manner, so as to form a thin keyboard structure. A backlight module 360 includes a light source 362 and a light guide plate 364. The light guide plate 364 is disposed between a vibrating plate 334 and the keyboard frame 320, and the light guide plate 364 extends under a plurality of touch units 340. The light source 362 is disposed on a horizontal lateral side of the light guide plate 364 for emitting light L to the light guide plate 364, and the light guide plate 364 guides the light L toward a bottom surface of the touch units 340 and converts the light L into backlight. Then the backlight emits out of the feedback keyboard structure 300 through the transparent keycap 342 or a second light penetrating portion 343 of the keycap 342.

As shown in FIG. 5, the light L emitted from the light source 362 is not limited to diffuse through the light guide plate 364. A haptic feedback device 330 can be made of transparent material having the same function as the light guide plate 364, so that the haptic feedback device 330 guides the light L emitted from the light source 362 toward the bottom surface of the plurality of touch units 340.

Please refer to FIG. 6. A feedback keyboard structure 301 is illustrated in FIG. 6. The light guide plate 364 of the feedback keyboard structure 301 does not have a through hole, and the backlight module 360 is disposed on the haptic feedback device 330. The backlight module 360 vibrates with the haptic feedback device 330 to generate a flashing light effect when the haptic feedback device 330 vibrates.

Please refer to FIG. 7. A feedback keyboard structure 302 is illustrated in FIG. 7. The backlight module 360 of the feedback keyboard structure 302 is disposed between the haptic feedback device 330 and the keyboard frame 320. When one of the keycaps 124 moves downward to contact against the corresponding switching unit, the light guide plate 364 of the backlight module 360 is deformed at a position corresponding to the contacted switching unit.

The backlight module 360 is disposed between the vibrating plate 334 and the keyboard frame 320 as the above-mentioned description, but the present invention is not limited to this. The vibrating plane 334 can be combined with the backlight module 360. Please refer to FIG. 8, a feedback keyboard structure 303 is illustrated in FIG. 8. The vibrating plate 334 of the feedback keyboard structure 303 can be combined with the backlight module 360 or has the function of the light guide plate 364. That is, the vibrating plate 334 can not only vibrate but also provide the light L to the plurality of touch units 340.

Please refer to FIG. 9 and FIG. 10. A feedback keyboard structure 304 is illustrated in FIG. 9. The light source 362 and the light guide plate 364 of the feedback keyboard structure 304 are disposed between the vibrating plate 334 and the base plate 310. A feedback keyboard structure 305 is illustrated in FIG. 10. The backlight module 360 of the feedback keyboard structure 305 replaces the base plate 310.

In addition, the vibrating plate 334 includes a first light penetrating portion 335, and each touch unit 340 includes the second light penetrating portion 343 so that the light L travels through the vibrating plate 334 and the touch unit 340. The first light penetrating portion 335 and the second light penetrating portion 343 can be respectively a through hole or made of transparent material. The light L is transmitted under the first light penetrating portion 335 through the light guide plate 364 and then travels upwards to a lower side of the keycap 342 through the first light penetrating portion 335. And then, the light L emits out through the transparent keycap 342 or the second light penetrating portion 343 of the keycap 342, as shown in FIG. 9 and FIG. 10.

In contrast with the prior art, the haptic feedback keyboard structure of the present invention generates haptic feedback so as to provide the haptic sensation in response of the operation when the keycap is pressed. In addition, the haptic feedback keyboard structure of the present invention includes thinner touch units so as to reduce a total thickness of the haptic feedback keyboard structure. Comparing with the conventional scissor structure, the thinner touch units with smaller pressing movement of the present invention can keep tactile sensation by the vibrating force generated by the haptic feedback device. Besides, the keycap, the resilient connecting component and the keyboard frame can be formed integrally to reduce components and simplify the assembly process so as to decrease the cost in molding. Therefore, the integral haptic feedback keyboard structure of the present invention has less weight and reduced thickness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A haptic feedback keyboard structure comprising:
a base plate;
a keyboard frame disposed on the base plate;
a haptic feedback device disposed between the base plate and the keyboard frame, the haptic feedback device comprising a vibrating plate;
a touch sensor disposed under the keyboard frame for triggering the vibrating plate to vibrate; and
a plurality of touch units respectively connected to the keyboard frame and adjacent to the touch sensor;
wherein when either one of the plurality of touch units is pressed, the touch sensor triggering the vibrating plate to transmit a vibrating force to the touch pressed unit.

2. The haptic feedback keyboard structure of claim 1, wherein the keyboard frame comprises a plurality of openings for respectively containing the plurality of touch units.

3. The haptic feedback keyboard structure of claim 1, wherein the touch sensor comprises a plurality of switching units respectively corresponding to the plurality of touch units.

4. The haptic feedback keyboard structure of claim 1, wherein each touch unit comprises a keycap and a resilient connecting component connected to the keycap and the keyboard frame, and the resilient connecting component is for damping vibration so as to reduce the vibrating force transmitted from the haptic feedback device to the keyboard frame.

5. The haptic feedback keyboard structure of claim 4, wherein the keycap, the resilient connecting component and the keyboard frame are formed integrally.

6. The haptic feedback keyboard structure of claim 1, further comprising a vibration damper disposed between the vibrating plate and the base plate for reducing the vibrating force transmitted from the haptic feedback device to the base plate.

7. The haptic feedback keyboard structure of claim 1, further comprising a backlight module comprising a light source and a light guide plate, the light source being disposed on a horizontal lateral side of the light guide plate for emitting light to the light guide plate, and the light guide plate converting the light into backlight.

8. The haptic feedback keyboard structure of claim 7, wherein the vibrating plate is combined with the backlight module so as to transmit the backlight to the one of the plurality of touch units.

9. The haptic feedback keyboard structure of claim 8, wherein the backlight module is disposed between the vibrating plate and the keyboard frame.

10. The haptic feedback keyboard structure of claim 8, wherein the backlight module is disposed between the vibrating plate and the base plate, or the light guide plate is the base plate, the vibrating plate comprises a first light penetrating portion, and the first light penetrating portion is a through hole or made of transparent material.

11. The haptic feedback keyboard structure of claim 10, wherein each touch unit comprises a second light penetrating portion, the second light penetrating portion is a through hole or made of transparent material, the backlight is transmitted out of the haptic feedback keyboard structure through the second light penetrating portion.

12. A haptic feedback keyboard structure comprising:
a base plate;
a keyboard frame disposed on the base plate;
a plurality of touch units, each of the plurality of touch units comprising a keycap and a resilient connecting component disposed between the keycap and the keyboard frame so that the keycap capable to move up and down relative to the keyboard frame;
a haptic feedback device disposed between the base plate and the keyboard frame, and the haptic feedback device extended across and under the plurality of touch units; and
a plurality of switching units, each of the plurality of switching units being disposed between one of the plurality of keycaps and the haptic feedback device;
wherein when one of the plurality of touch units is pressed to move the corresponding keycap downward to contact against the corresponding switching unit, so that the corresponding switching unit contacts against the haptic feedback device, the haptic feedback device is triggered and transmits a vibrating force to the pressed keycap through the contacted switching unit, and the resilient connecting component reduces the vibrating force further transmitting from the pressed keycap to the keyboard frame, meanwhile the other of the plurality of touch units is not pressed so that the corresponding switching units do not move downward to contact against the haptic feedback device, and the unpressed touch units do not receive the vibrating force to substantially remain motionless.

13. The haptic feedback keyboard structure of claim 12, wherein the keyboard frame comprises a plurality of openings, and each opening contains one of the plurality of keycaps, each of the openings has a shape corresponding to a shape of the contained keycap, and gaps between the keyboard frame and each of the plurality of keycaps are substantially the same.

14. The haptic feedback keyboard structure of claim 12, wherein the keycap and the resilient connecting component are formed integrally, and the keycap is harder than the resilient connecting component.

15. The haptic feedback keyboard structure of claim 12, further comprising a vibration damper disposed between the vibrating plate and the base plate for reducing the vibrating force transmitted from the vibrating plate to the base plate.

16. The haptic feedback keyboard structure of claim 12, further comprising a backlight module disposed on the haptic feedback device, and the backlight module vibrating with the haptic feedback module to generate a flashing light effect when the haptic feedback device vibrates.

17. The haptic feedback keyboard structure of claim 12, further comprising a backlight module disposed between the haptic feedback device and the keyboard frame, and when one of the plurality of the keycap moves downward to contact against the corresponding switching unit, the backlight module is deformed at a position corresponding to the contacted switching unit.

18. The haptic feedback keyboard structure of claim 12, further comprising a backlight module under the haptic feedback device, the haptic feedback device comprising a first light penetrating portion, and the first light penetrating portion being a through hole or made of transparent material.

19. The haptic feedback keyboard structure of claim 12, further comprising a backlight module, the backlight module comprising a light source for emitting light and a light guide plate disposed under the plurality of touch units and for guiding the light emitted from the light source toward a bottom surface of the plurality of touch units.

20. The haptic feedback keyboard structure of claim 12, further comprising a light source for emitting light, the haptic feedback device being made of transparent material, and the haptic feedback device guiding the light emitted from the light source toward the bottom surface of the plurality of touch units.
